(19) United States
(12) Patent Application Publication
(10) Pub. No.: US 2014/0199612 A1
(43) Pub. Date: Jul. 17, 2014

(54) SOLID OXIDE FUEL CELL HAVING HYBRID SEALING STRUCTURE

(71) Applicant: Samsung Electronics Co., Ltd., Suwon-si (KR)

(72) Inventors: Ju-sik KIM, Seoul (KR); Dong-hee YEON, Seoul (KR); Chan KWAK, Yongin-si (KR); Doh-won JUNG, Seoul (KR)

(73) Assignee: Samsung Electronics Co., Ltd., Suwon-si (KR)

(21) Appl. No.: 13/974,894

(22) Filed: Aug. 23, 2013

(30) Foreign Application Priority Data
Jan. 16, 2013 (KR) 10-2012-0005118

(51) Int. Cl. H01M 8/02

(52) U.S. Cl. CPC H01M 8/0282
USPC 429/482

(57) ABSTRACT

A solid oxide fuel cell (“SOFC”) sealed with a multi-layered hybrid structure, the SOFC including: a cathode layer; a cathode current collector in contact with the cathode layer; an anode layer corresponding to the cathode layer; an anode current collector in contact with the anode layer; an electrolyte layer disposed between the cathode layer and the anode layer; a reaction barrier layer disposed between the electrolyte layer and the cathode layer; and at least two different types of sealing materials.

### CROSS-REFERENCE TO RELATED APPLICATIONS

This application claims priority to Korean Patent Application No. 10-2013-0005118, filed on Jan. 16, 2013, and all the benefits accruing therefrom under 35 U.S.C. §119, the content of which in its entirety is herein incorporated by reference.

### BACKGROUND

1. Field

The disclosure relates to a fuel cell, and more particularly, to a solid oxide fuel cell (“SOFC”) having a hybrid sealing structure.

2. Description of the Related Art

In an SOFC, a sealing material (e.g., sealant) typically prevents the explosion of a fuel cell stack by preventing a fuel and air from being mixed together at high temperatures. The sealing material also maintains a partial pressure difference between an anode and a cathode, thereby constantly maintaining an electromotive force.

In the SOFC, the sealing material may stay structurally/chemically stable in relation to other components of a fuel cell during an operation at a temperature in a range from 650° C. to 800° C. to maintain a high performance gas-tight sealing property. In the SOFC, a rapid thermal cycle and vibrations typically occur and thermal stress may be generated due to a difference in coefficients of thermal expansion of components thereof.

### SUMMARY

Provided are embodiments of a solid oxide fuel cell (“SOFC”) which has improved durability against thermal and mechanical impacts as well as a gas-tight sealing property due to the presence of a hybrid sealing structure.

An embodiment of a SOFC sealed with a multi-layered hybrid structure, includes a cathode layer; a cathode current collector in contact with the cathode layer; an anode layer corresponding to the cathode layer; an anode current collector in contact with the anode layer; an electrolyte layer disposed between the cathode layer and the anode layer; a reaction barrier layer disposed between the electrolyte layer and the cathode layer; and at least two different types of sealing materials.

In an embodiment, the cathode layer and the anode layer may be sealed with different sealing materials of the at least two different types of sealing materials, respectively.

According to an embodiment of the invention, the side of the anode layer in the SOFC may be sealed with a first sealing material of the at least two different types of sealing materials.

According to an embodiment of the invention, a side of the electrolyte layer in the SOFC may be sealed with a second sealing material of the at least two different types of sealing materials.

According to an embodiment of the invention, the cathode layer in the SOFC may be sealed with a third sealing material of the at least two different types of sealing materials, which is different from the first sealing material.

According to an embodiment of the invention, the third sealing material may include a non-glass type sealing material.

According to an embodiment of the invention, the third sealing material in the SOFC may cover a portion of the electrolyte layer adjacent to the second sealing material.

According to an embodiment of the invention, the third sealing material in the SOFC may have a multi-layered structure including a plurality of layers, where the coefficient of thermal expansion of one of the plurality of layers may be different from the coefficient of thermal expansion of another of the plurality of layers.

According to an embodiment of the invention, the third sealing material in the SOFC may include a first sealing material layer, a second sealing material layer, and a third sealing material layer, where the coefficient of thermal expansion of the second sealing material layer may be less than the coefficients of thermal expansion of the first and third sealing material layers.

According to an embodiment of the invention, the third sealing material in the SOFC may include a plurality of mica layers, where the coefficient of thermal expansion of one of the mica layers is different from the coefficient of thermal expansion of another of the plurality of mica layers.

According to an embodiment of the invention, the coefficient of thermal expansion of the first and third sealing material layers may be substantially the same as each other.

According to an embodiment of the invention, the multi-layered structure in the SOFC may have a substantially symmetric structure, where the coefficient of thermal expansion may increase upwardly or downwardly from a center layer of the multi-layered structure.

According to an embodiment of the invention, the center layer may in the SOFC be a first non-glass type material layer.

According to an embodiment of the invention, the upper and lower layers of the multi-layered structure may be second non-glass type material layers.

According to an embodiment of the invention, the first non-glass type material layer in the SOFC may be a mica layer.

According to an embodiment of the invention, the second non-glass type material layers in the SOFC may include a mica or ceramic support.

According to an embodiment of the invention, the third sealing material in the SOFC may be a non-glass type material.

According to an embodiment of the invention, the first sealing material in the SOFC may include a glass type material or glass-ceramic composite.

According to an embodiment of the invention, the second sealing material in the SOFC may include a glass type material, glass-ceramic composite or ceramic.

According to an embodiment of the invention, the first sealing material in the SOFC may include an amorphous or crystalline multi-membered composite.

According to an embodiment of the invention, the SOFC may further include an anode functional layer disposed between the anode layer and the electrolyte layer.

According to embodiments of the invention, the SOFC has a hybrid sealing structure where the sealing material for an anode or anode-electrolyte domain is different from the sealing material for an electrolyte-cathode domain. Accordingly, the SOFC has a substantially improved gas sealing property and thermal cycle characteristic due to low thermal stress, and effectively prevents diffusion of a silicon gas to the cathode, thereby substantially increasing durability.

### BRIEF DESCRIPTION OF THE DRAWINGS

These and/or other features will become apparent and more readily appreciated from the following description of the embodiments, taken in conjunction with the accompanying drawings, in which:

FIG. 1 is a cross-sectional view of an embodiment of a unit cell of a solid oxide fuel cell (“SOFC”) according to the invention;

FIG. 2 is a graph illustrating an experimental result of thermal cycle durability measurement of an embodiment of an SOFC according to the invention; and

FIG. 3 is a graph illustrating an experimental result of evaluating the durability of a cathode layer according to a sealing material of an SOFC, according to an embodiment of the invention.

### DETAILED DESCRIPTION

The invention will be described more fully hereinafter with reference to the accompanying drawings, in which embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, embodiments of a solid oxide fuel cell (“SOFC”) having a hybrid sealing structure according to the invention will be described in detail with reference to the accompanying drawings. FIG. 1 is a cross-sectional view of an embodiment of a unit cell of an SOFC according to the invention.

Referring to FIG. 1, the unit cell includes an anode layer 42 disposed on an anode current collector 40. A width of the anode layer 42 may be greater than a width of the anode current collector 40. In an embodiment, the anode current collector 40 may include nickel. The anode layer 42 may function as a support for a fuel cell. In an embodiment of manufacturing the unit cell, the anode layer 42 may be provided, e.g., formed, by mixing nickel oxide-yttria stabilized zirconia (“NiO—YSZ”) powder, a binder and a carbon black pore-forming material using a ball-milling method, providing a form of the anode layer 42 using a tape casting method and sintering the form of the anode layer 42.

In an embodiment of the unit cell, an electrolyte layer 44 is disposed on the anode layer 42. The level of flatness of the surface of the anode layer 42, on which the electrolyte layer 44 is dispose, may be less than about 100 micrometers (μm). In an embodiment of a method of manufacturing the unit cell, the electrolyte layer 44 may be provided, e.g., formed, by mixing scandia stabilized zirconia (“ScSZ”) powder, a binder and a carbon black pore-forming material using a ball-milling method, providing a form of the electrolyte layer 44 using a tape casting method and sintering the form of the electrolyte layer 44. In one embodiment, for example, the mixture for providing the electrolyte layer 44 may include about 50 grams (g) of scandia ceria stabilized zirconia (“ScCeSZ”), about 25 g of toluene, about 6.3 g of ethanol, about 0.83 g of a dispersing agent, and about 20 g of a binder.

In an embodiment, the unit cell may further include an anode functional layer (“AFL”) (not shown) disposed between the electrolyte layer 44 and the anode layer 42. In an embodiment of a method of manufacturing the unit cell, the anode functional layer may be provided, e.g., formed, by mixing nickel oxide-scandia stabilized zirconia (“NiO—ScSZ”) powder, a binder and a carbon black pore-forming material using a ball-milling method, providing a form of the anode functional layer using a tape casting method and sintering the form of the anode functional layer. In one embodiment, for example, the mixture for providing the anode functional layer may include about 30 g of NiO, about 20 g of ScCeSZ, about 2 g of graphite, about 30.4 g of toluene, about 7.6 g of ethanol, about 1.23 g of a dispersing agent, and about 21.5 g of a binder. In an embodiment of a method of manufacturing the unit cell, the anode layer 42 and the electrolyte layer 44, respectively formed by a tape casting method, are stacked via lamination and Warm Isotropic Press (“WIP”) methods, and the resultant is sintered at 1400° C. via a sinter-forging method. In such an embodiment, a stack including the sequentially stacked anode layer 42 and electrolyte layer 44 may be obtained by the sintering. In an embodiment, when the sintering is performed for the anode layer 42 and the electrolyte layer 44 including the anode functional layer therebetween, a stack, in which the anode layer 42, the anode functional layer and the electrolyte layer 44 are sequentially stacked, may be obtained.

In an embodiment of the unit cell, a first stack including a collector 40, an anode layer 42 and an electrolyte layer 44 is disposed, e.g., buried, in a lower metal frame 30. A plurality of separated first passages 32, through which a gas is introduced, is defined in a portion of the lower metal frame 30 where the first stack is buried. In the first stack, the collector 40 may be disposed to cover the first passages 32. The gas, which is introduced through the first passage 32, may be a fuel gas including hydrogen, for example. In an embodiment of the unit cell, the space between opposing sides of the anode layer 42 and the lower metal frame 30 is sealed with a first sealing material 52 as an anode sealing material. A thickness t1 of the first sealing material 52 may be in a range of about 0.05 millimeter (mm) to about 3 millimeters (mm).

In one embodiment, for example, the first sealing material 52 may be an amorphous or crystalline glass-type material. In one embodiment, the glass-type material may be, for example, a composite (e.g., a multi-membered composite) which includes a plurality of components having AlO, MgO, BO, BaO and SiO₂ as a base. In such an embodiment, the glass-type material may be a 2-membered, 3-membered, or 4-membered composite, and may be a 5 or more membered composite. In one embodiment, for example, the glass-type material may be a 2-membered composite including B₂O₃—BaO, a 4-membered composite including B₂O₃—MgO—BaO—SiO₂, or a 5-membered composite including B₂O₃—BaO—MgO—AlO—SiO₂. In an alternative embodiment, the first sealing material 52 may be a glass-ceramic composite, which is formed by mixing a glass-type material and a ceramic. The first sealing material 52 may extend in a downward direction to a portion lower than the anode layer 42.

A width of the electrolyte layer 44 may be substantially the same as a width of the anode layer 42. In an embodiment of the unit cell, a space between the sides of the electrolyte layer 44 and the lower metal frame 30 is sealed with a second sealing material 54. In one embodiment, for example, the second sealing material 54 may be ceramic. In an embodiment, where the second sealing material 54 is provided, when a gas, for example Si gas, is generated from the first sealing material 52 during the operation of a fuel cell, the diffusion or movement of the gas into the cathode layer 48 is effectively prevented. In such an embodiment, the second sealing material 54 may be a glass-type material or a glass-ceramic composite.

In an embodiment of the unit cell, a reaction barrier layer 46 and a cathode layer 48 are sequentially stacked on the electrolyte layer 44. In such an embodiment, the reaction barrier layer 46 may be a gadolinium doped ceria oxide (“GDC”) membrane, for example, and the cathode layer 48 may be a (Ba_{0.5}Sr_{0.5})(Co_{0.8}Fe_{0.2})₁₋ₓZrₓO₃-δ (“BSCFZ”) layer, for example. In an embodiment of a method of manufacturing the unit cell, the reaction barrier layer 46 and the cathode layer 48 may be provided, e.g., formed, by first preparing a reaction barrier material and a cathode material paste using a 3-roll milling method, and then sequentially coating the reaction barrier material and the cathode material paste on the electrolyte layer 44 using a screen printing method.

In an embodiment a cathode current collector 50 is disposed on the cathode layer 48. In such an embodiment, the cathode current collector 50 may be provided using Ag. In an embodiment of the unit cell, the cathode current collector 50 is covered with an upper metal frame 34. In an embodiment of the unit cell, a plurality of separated second passages 36 are defined on a portion of the upper metal frame 34 where the upper metal frame 34 is in contact with the cathode current collector 50. The second passages 36 may supply a gas including oxygen. In such an embodiment, the second passages 36 may be covered with the cathode current collector 50. In an embodiment of a unit cell of a fuel cell, an anode current collector 40 and a cathode current collector 50, an anode layer 42 and a cathode layer 48, an electrolyte layer 44, a reaction barrier layer 46 and first and second sealing materials 52 and 54 are disposed between the upper metal frame 34 and lower metal frame 30.

In an embodiment, a third sealing material (S1) is disposed between the upper metal frame 34 and lower metal frame 30 around the cathode layer 48 and the reaction barrier layer 46. A space between the lower and upper metal frames 30 and 34 is sealed with the third sealing material (S1).

In an embodiment, the third sealing material (S1) covers the second sealing material 54, and may cover a portion of the electrolyte layer 44, which is adjacent to the second sealing material 54. In an alternative embodiment, the second sealing material 54 may be replaced with the first sealing material 52, and in such an embodiment, the silicon gas that is generated may be effectively prevented from arriving at the cathode layer 48 by the third sealing material (S1) when a silicon gas is generated from the first sealing material 52 due to silicon vaporization during the operation of a fuel cell. A thickness of the third sealing material (S1), for example, may be in a range of about 0.1 mm to about 5 mm. In an embodiment, as shown in FIG. 1, the third sealing material (S1) is spaced apart from both the reaction barrier layer 46 and the cathode layer 48. In such an embodiment, an empty space 62 is defined between the third sealing material (S1) and the reaction barrier layer 46 and the cathode layer 48. In an alternative embodiment, the empty space 62 may be filled with the third sealing material (S1). The third sealing material (S1) may be sealed under a pressure, for example, under about 0.06 megapascal (Mpa) of pressure. In such an embodiment, the third sealing material (S1) improves the thermal cycle characteristics and durability of the cathode layer 48 during the operation of the fuel cell.

In one embodiment, for example, the third sealing material (S1) may include a non-glass type material. In such an embodiment, the third sealing material (S1) including the non-glass type material may have a multi-layered structure including mica and ceramic fiber. In an embodiment, the third sealing material (S1) may have a multi-layered structure including a plurality of sealing materials having different coefficients of thermal expansion from each other. In such a multi-layered structure, a coefficient of thermal expansion thereof may increase in an upward and/or downward direction from the center layer. In such a multi-layered structure, coefficients of thermal expansion the upper part and the lower part may be substantially symmetric to each other with respect to the center layer. In such a multi-layered structure, the third sealing material (S1) may include the first sealing material layer 56, the second sealing material layer 58 and the third sealing material layer 60, which are sequentially stacked. The coefficient of thermal expansion of the second sealing material layer 58, which is the center layer of the third sealing material (S1), may be less than coefficients of thermal expansion of the first and third sealing material layers 56 and 60. The coefficients of thermal expansion of the first sealing material layer 56 and the third sealing material layer 60 may be substantially the same as or different from each other. Materials of the first sealing material layer 56 and the third sealing material layer 60 may be substantially the same as or different from each other.

In an embodiment, the first sealing material layer 56, which is in contact with the lower metal frame 30, may be a ceramic fiber, for example. In such an embodiment, the ceramic fiber may include, for example, alumina fiber or Ag—CuO. In an embodiment, the first sealing material layer 56 may be mica, for example, but the coefficient of thermal expansion of the first sealing material may be greater than the coefficient of thermal expansion of the mica which may be included in the second sealing material layer 58. In an embodiment, the third sealing material layer 60, which is in contact with the upper metal frame 34, may be the ceramic support. In an embodiment, the third sealing material layer 60 may also be mica, but the coefficient of thermal expansion of the third sealing material layer 60 may be greater than the coefficient of thermal expansion of the mica which may be included in the second sealing material layer 58. In an embodiment, the second sealing material layer 58 may include, for example, mica, and the mica included in the second sealing material layer 58 may include muscovite (KAl₁₂(AlSi₃O₁₀)(F.OH)₂), or phlogopite (KMg₃(AlSi₃O₁₀)(OH)₂).

In an embodiment, a first additional sealing material (not shown) may be disposed between the first sealing material layer 56 and the second sealing material layer 58. In such an embodiment, the coefficient of thermal expansion of the first additional sealing material layer may be less than the coefficient of thermal expansion of the first sealing material layer 56 and greater than the coefficient of thermal expansion of the second sealing material layer 58. In an embodiment, a second additional sealing material may be disposed between the second sealing material layer 58 and the third sealing material layer 60. Here, the coefficient of thermal expansion of the second additional sealing material layer may be less than the coefficient of thermal expansion of the third sealing material layer 60, and greater than the coefficient of thermal expansion of the second sealing material layer 58.

Experiments for measuring the properties of SOFCs and the results thereof will hereinafter be described in detail.

First, experiments and results thereof in regard to sealing properties and thermal cycle durability of SOFCs will now be described.

### (1) Experiment for Measuring Sealing Property and Results Thereof

An experiment for measuring a sealing property was conducted, and the level of gas leakage via a sealing material was measured.

In the experiment, the exhaust gas line of an embodiment of a SOFC according to the invention was connected to a mass spectroscope, and analysis of the gas components was performed. In this experiment, a crystalline glass composite was used as the sealing material for the anode layer 42. Mica and alumina fiber were used as a sealing material for the electrolyte layer 44 and the cathode layer 48, and the sealing materials were compressed under about 0.06 Mpa of pressure and sealed.

The results of the experiment for measuring the sealing property are as follows.

Under gas components analysis, O₂ and N₂ were respectively detected to be less than about 0.01% at a temperature in a range of 600° C. to 800° C., thus confirming the improved sealing property of the sealing material. Furthermore, an open circuit voltage (“OCV”) was about 1.17 volts (V), which is substantially close to the theoretical maximum value of about 1.2 V.

### (2) Experiment for Measuring Thermal Cycle Durability and Results Thereof

In order to analyze the durability of a sealing material against thermal shock, thermal cycles were performed a total of 10 times in a temperature in a range of 300° C. to 700° C. and the components of the exhaust gas were analyzed. Temperature fluctuation during each thermal cycle was set at about 5 degrees Celsius per minute (° C./min).

In performing the experiment for measuring the thermal cycle durability, the sealing materials for the anode layer 42, the electrolyte layer 44 and the cathode layer 48 were substantially the same as in the experiment for measuring the sealing property. In addition, an experiment was also performed to measure the thermal cycle durability of a fuel cell using mica as the only sealing material for the anode layer 42, the electrolyte layer 44 and the cathode layer 48.

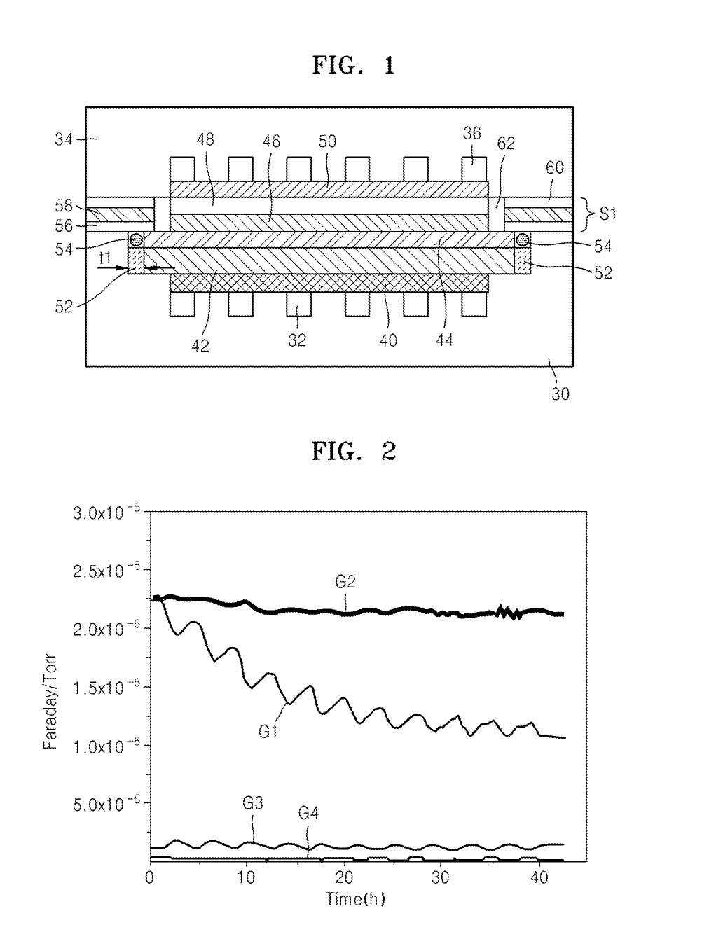

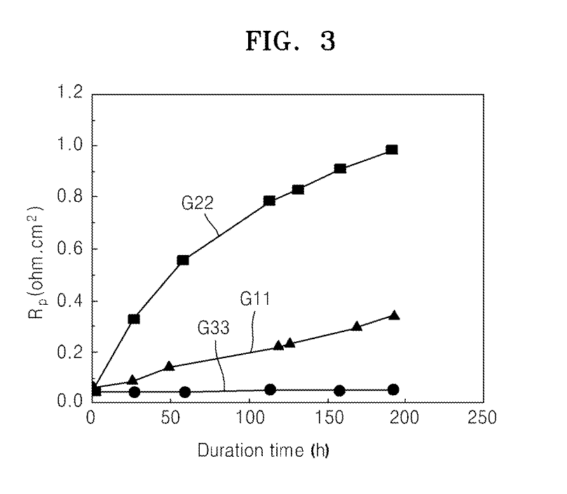

FIG. 2 shows a graph illustrating the experimental results of thermal cycle durability measurement, in which the x axis represents time (hour: h) and the y axis represents Faraday per Torr. In FIG. 2, the first graph G1 represents a comparative embodiment where only mica was used as a sealing material for the anode layer 42, the electrolyte layer 44 and the cathode layer 48, and the second graph G2 represents an embodiment according to the invention where the sealing material for the anode layer 42, the electrolyte layer 44 and the cathode layer 48 has a hybrid structure.

As shown in the first and second graphs G1 and G2 of FIG. 2, when the mica was used as the only sealing material (G1), the leakage of H₂ gas was less than about 1% at the initial stage of the operation, but the H₂ gas leakage increased to about 8% after performing thermal cycles 10 times, which may be caused by the interfacial debonding due to the coefficient of thermal expansion of mica which is relatively low. Basically, mica has a layered-structure elastic body and thus a coefficient of thermal expansion mismatch may occur between the mica and the components (electrolytes and a metal support) during each thermal cycle. The coefficient of thermal expansion mismatch results in the interfacial debonding even under mechanical compression. Accordingly, when mica is used as the only sealing material, a sealing may be effectively provided at the initial stage of the operation, but with repeated thermal cycles the sealing will be weak as shown in FIG. 2. In an embodiment, where the sealing of the anode layer 42, the electrolyte layer 44 and the cathode layer 48 has a hybrid structure (G2), the gas leakage rate, even after performing thermal cycles 10 times, is maintained at a level of about 0.1% or less as is the case with the initial operation stage, thus the sealing property is substantially improved. In such an embodiment, the durability of the sealing material according to thermal cycles is substantially improved.

In FIG. 2, the third graph G3 represents the result of N₂ gas leakage in the comparative embodiment where mica was used as the only sealing material for the anode layer 42, the electrolyte layer 44 and the cathode layer 48. The fourth graph G4 represents the result of N₂ gas leakage in the embodiment of the invention where the sealing material for the anode layer 42, the electrolyte layer 44 and the cathode layer 48 has a hybrid structure.

Referring to the third and fourth graphs G3 and G4 in FIG. 2, the N₂ gas leakage in the embodiment of the invention is substantially maintained at the initial level even after repeated thermal cycles.

Next, an experiment for the evaluation of the durability of a cathode layer according to a sealing material and the results thereof will hereinafter be described.

A planar type fuel cell typically has a relatively larger sealing area than other types of fuel cell, for example, a cylindrical or plain type fuel cell, and the sealing material is directly exposed to an operation atmosphere. Therefore, the sealing material of the planar type fuel cell may affect the function of the cathode layer. Glass-type sealing material includes a SiO₂ composition as a base, and thus silicon (Si) vaporization may cause functional deterioration of the cathode layer. In an embodiment, a sealing material is selected not to deteriorate the function of the cathode layer for improving the durability of a planar type fuel cell stack. Hereinafter, experiments performed to examine the durability of the cathode layer according to a sealing material will be described. In the experiments, pyrex, which was used as a glass-type sealing material, and a multi-layered sealing material including alumina felt/ ceramic/ pyrex (about 0.03 g) used as a non-glass type sealing material, were positioned around the electrolytes of cathode layer symmetric cell, and polarization resistance of the cathode layer over time was analyzed. The multi-layered sealing material used as the non-glass type sealing material is a hybrid multi-layered sealing material which covers the glass-type sealing material (e.g., pyrex) with a non-glass type sealing material.

FIG. 3 shows an experimental result of evaluating the durability of a cathode layer conducted as such. In FIG. 3, the x axis represents time (h), and the y axis represents contact resistance (ohm·cm²). In FIG. 3, the first graph G11 shows a result when about 0.03 g of pyrex was used as the glass-type sealing material. The second graph G22 shows a result when about 0.3 g of pyrex was used as the glass-type sealing material. The third graph G33 shows a result when a hybrid multi-layered sealing material (alumina felt/ceramic/pyrex), which covers the glass-type sealing material (e.g., pyrex), was used as the non-glass type sealing material.

Referring to the first to third graphs G11 to G33 of FIG. 3, in a cell where pyrex as the glass-type sealing material is included, e.g., G11 and G22, the resistance after about 200 hours of operation increases according to the amount of the sealing material as compared to the initial resistance. In particular, when about 0.03 g of pyrex was used as the sealing material, the resistance after about 200 hours of operation showed about a six-fold increase (G11) compared to the initial resistance. Furthermore, when about 0.3 g of pyrex was used as the sealing material, the resistance after about 200 hours of operation showed about a twenty-fold increase (G22) compared to the initial resistance. In contrast, when a hybrid multi-layered sealing material was used as shown in the third graph (G33), the resistance in the vicinity of about 200 hours of operation was substantially maintained at a low level as is the case of the initial resistance.

Considering that the major difference between a glass-type sealing material and a non-glass type sealing material lies in the presence/absence of a silicon gas, the difference in resistance between the glass-type sealing material and the non-glass type sealing material suggests that the silicon gas generated due to silicon vaporization in the glass-type sealing material may be the main cause that deteriorates the function of the cathode layer. When the silicon inside the pyrex is vaporized and deposited on the surface of the cathode layer, the reaction area for the oxygen reduction is decreased, and thus the function of the cathode layer may deteriorate.

Accordingly, the result of the third graph (G33) shows that in an embodiment where a hybrid multi-layered sealing material which covers the glass-type sealing material with a non-glass type sealing material, silicon vaporization from the glass-type sealing material is effectively inhibited

The result of FIG. 3 shows that, in an embodiment of an SOFC having a hybrid multi-layered sealing structure where a non-glass type sealing material is used as the sealing material for the cathode layer 48, and a glass type sealing material is used as the sealing material for the anode layer 42, according to the invention, the functional deterioration of the cathode layer 48 is effectively prevented, and is the function of the cathode layer 48 is substantially maintained at the level of initial operation.

In the experiments, when impedance for the symmetric cell was measured at the 160 hours after the operation, the impedance in the cell where pyrex was used as the sealing material were substantially increased at the high frequency area, e.g., about 200 hertz (Hz) compared to the cell where alumina felt was used as the sealing material.

Here, the impedance at the low frequency area, e.g., about 1 Hz, which is associated with the diffusion and movement of oxygen gas, was not substantially increased while the impedance at the high frequency area related to the surface exchange reaction was substantially increased.

Since the surface exchange reaction includes surface absorption of reactants and charge transfer, it may be influenced by the reaction area and the state of the surface. When a material having a phase with a very low ionic and electronic conductivity is adsorbed to the surface of an electrode, the surface exchange reaction on the electrode surface of a mixed conductive material may be affected, thus increasing the polarization resistance regarding the oxygen reduction. Accordingly, in an embodiment, where pyrex is used as a sealing material of the cathode layer, silicon is vaporized from the pyrex, and a non-conductive metal-silicate phase may be formed on the surface of the cathode layer, which substantially reduces the reaction area of the cathode layer surface, thereby effectively preventing oxygen reduction.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A solid oxide fuel cell (SOFC) sealed with a multi-layered hybrid structure, the SOFC comprising:
a cathode layer;
a cathode current collector in contact with the cathode layer;
an anode layer corresponding to the cathode layer;
an anode current collector in contact with the anode layer;
an electrolyte layer disposed between the cathode layer and the anode layer;
a reaction barrier layer disposed between the electrolyte layer and the cathode layer; and
at least two different types of sealing materials.

2. The SOFC of claim 1, wherein the cathode layer and the anode layer are sealed with different sealing materials of the at least two different types of sealing materials, respectively.

3. The SOFC of claim 1, wherein a side of the anode layer is sealed with a first sealing material of the at least two different types of sealing materials.

4. The SOFC of claim 3, wherein a side of the electrolyte layer is sealed with a second sealing material of the at least two different types of sealing materials.

5. The SOFC of claim 4, wherein the cathode layer is sealed with a third sealing material of the at least two different types of sealing materials, which is different from the first and second sealing materials.

6. The SOFC of claim 5, wherein the third sealing material comprises a non-glass type sealing material.

7. The SOFC of claim 5, wherein the third sealing material covers a portion of the electrolyte layer adjacent to the second sealing material.

8. The SOFC of claim 5, wherein
the third sealing material has a multi-layered structure including a plurality of layers, wherein the coefficient of thermal expansion of one of the plurality of layers is different from the coefficient of thermal expansion of another of the plurality of layers.

9. The SOFC of claim 8, wherein
the third sealing material comprises a first sealing material layer, a second sealing material layer, and a third sealing material layer, which are sequentially stacked,
wherein the coefficient of thermal expansion of the second sealing material layer is less than the coefficients of thermal expansion of the first and third sealing material layers.

10. The SOFC of claim 8, wherein
the third sealing material comprises a plurality of mica layers, wherein the coefficient of thermal expansion of one of the plurality of mica layers is different from the coefficient of thermal expansion of another of the plurality of mica layers.

11. The SOFC of claim 9, wherein the coefficient of thermal expansion of the first and third sealing material layers are substantially the same as each other.

12. The SOFC of claim 8, wherein
the multi-layered structure has a substantially symmetric structure, wherein the coefficient of thermal expansion increases upwardly or downwardly from a center layer of the multi-layered structure.

13. The SOFC of claim 12, wherein the center layer is a first non-glass type material layer.

14. The SOFC of claim 13, wherein upper and lower layers of the multi-layered structure are second non-glass type material layers.

15. The SOFC of claim 13, wherein the first non-glass type material layer is a mica layer.

16. The SOFC of claim 14, wherein the second non-glass type material layers comprise a mica or ceramic support.

17. The SOFC of claim 3, wherein the first sealing material comprises a glass type material or glass-ceramic composite.

18. The SOFC of claim 4, wherein the second sealing material comprises a glass type material, glass-ceramic composite or ceramic.

19. The SOFC of claim 17, wherein the first sealing material comprises an amorphous or crystalline multi-membered composite.

20. The SOFC of claim 1, further comprising:
an anode functional layer disposed between the anode layer and the electrolyte layer.
